(19) United States
(12) Patent Application Publication
(10) Pub. No.: US 2002/0190404 A1
(43) Pub. Date: Dec. 19, 2002

(54) Gas/liquid contact chamber and a contaminated water treatment system incorporating said chamber

(76) Inventor: Isaac F. Baarda, Nashville, TN (US)

Correspondence Address: George Pappas, PAPPAS LAW OFFICE, Suite 300, 919 S. Harrison Street, Fort Wayne, IN, 46802, US

(21) Appl. No.: 10/104,630

(22) Filed: Mar. 22, 2002

Related U.S. Application Data
(60) Provisional application No. 60/278,883, filed on Mar. 27, 2001.

(51) Int. Cl. B01F 3/04

(52) U.S. Cl. 261/115; 261/116; 261/118; 261/DIG. 42

(57) ABSTRACT

This invention presents a unique gas/liquid contact chamber that produces intimate contact between a gas, such as ozone, and a liquid in a manner that promotes the greatest possible mass gas transfer of the gas into the liquid. This contact chamber may be coupled with other contaminated water treatment technologies giving contaminated water treatment systems that produce pure water. By the use of combinations of selected technologies specific contaminated water treatment problems, such as disinfection of wastewater treatment plant effluents or portable water treatment systems for emergency use, may be developed. Such water treatment systems also combine the use of fine spray technology, gas/liquid mixing technology, and fine bubble technology for mass gas transfer of gas into liquid. The contact chamber and the systems it can be combined with, are all simple, economical, easily constructed, and highly flexible in application and physical arrangement.

This application claims benefit in provisional application No. 60/278,883 filed on Mar. 27, 2001 and consists of two main subdivisions.

The first subdivision relates to the mass transfer of gaseous elements or compounds into liquids and, more specifically, to a unique Gas/Liquid Contact Chamber for efficient mass transfer of gaseous ozone into contaminated water for purposes of purification of said water.

The second subdivision relates to a Contaminated Water Treatment System incorporating said Gas/Liquid Contact Chamber and, more specifically, a Contaminated Water Treatment System, incorporating said Gas/Liquid Contact Chamber with other water treatment methodologies, that produces purified water from contaminated water sources.

### BACKGROUND OF INVENTION

Pure, fresh water is one of the most valuable commodities in today's world and human pollution is the predominant threat to the world's fresh water supply. A number of effective water and wastewater treatment methods are available but their initial and operating expenses limit their application, especially in the less economically fortunate areas of the world. A simple, economical, and flexible water purification system or methodology is needed.

The majority of contaminated water treatment methods use chemical oxidants or disinfectants at some point within the treatment system. The most commonly used chemical oxidant is chlorine, which is dangerous to handle and also produces a wide range of chlorinated byproducts in the treated water. Ozone is a more powerful oxidant than chlorine and does not produce toxic byproducts in the treated water.

Ozone is the metastable triatomic form of oxygen. It quickly decomposes to form oxygen and must therefore be produced at the site where it is used. It is quite soluble in water but decomposes faster in aqueous solution than it does in gaseous form.

The compounds to be oxidized by ozone are referred to as “target molecules”, and the objective of ozonation is to get as much ozone as possible in effective contact with the target molecules in the solution before the ozone is lost through autodestruction or wasted by venting to the atmosphere. If the objective of the treatment is disinfection of the water then the individual bacterial cells are the targets for the ozone molecules. Care must be exercised that clumps or particles of solid material in the water are broken up so that the microbial cells, spores, or cysts enclosed in those solid particles are exposed to the sterilizing effects of the ozone. No chemical oxidant is very effective at penetrating solids and destroying microbes hidden within or protected by these solid particles. The oxidizing potential of the oxidant is expended upon the solids rather than the microbes.

The major difficulty in ozone application is the lack of economically effective technology for mass transfer of ozone from gas to aqueous phase. Available technology primarily depends on methods for mixing gas and liquid or breaking the gas into small bubbles that mix with and rise through the aqueous solution to be treated. A lesser used method is based upon breaking up the liquid into fine droplets and exposing the droplets to gas containing ozone.

This patent application describes a new and unique Gas/Liquid Contact Chamber which rapidly and efficiently facilitates the mass transfer of ozone, or other gases, into liquids.

For the practical application of this new and unique mass transfer technology to the water purification industry it must be combined with other technologies to form a treatment system which makes use of the potential of the contact chamber technology. The Contaminated Water Treatment System described in this application satisfies that need.

### DESCRIPTION OF PRIOR ART

If ozone, a gas, is to be used to oxidize target molecules and destroy microbes in a liquid environment then the ozone must enter this liquid milieu to be effective. The rate of this mass gas transfer can be increased in several ways.

The mass gas transfer rate is increased by putting the gas/liquid mixture under pressure. Unfortunately, ozone autodestructs more rapidly under pressure. Equipment for pressurized systems is also more expensive and subject to leakage than equipment designed to operate at atmospheric pressure. This invention operates at or near atmospheric pressure.

The mass gas transfer rate is also increased by increasing the concentration of ozone in the gaseous phase. The production of highly concentrated ozone feed gas is costly because pure oxygen, usually obtained from liquid oxygen, is required as feed gas to the generator. Also, the higher the ozone concentration the more rapid the loss of ozone from autodestruction.

A common limiting factor for the rate of mass gas transfer from gas to liquid is the liquid surface area to volume ratio. This ratio is determined by the technology used to expose the gas and liquid to each other. This ratio is maximized in the Gas/Liquid Contact Chamber described in this patent application.

The liquid surface area to volume ratio may be increased by several methods. Three of these methods are discussed here.

The first method is based on physical agitation and mixing of the gas and liquid phases. The objective is to break the gas up into small bubbles and mix these thoroughly with the liquid while keeping the liquid in an agitated state to increase the liquid surface area exposed to the gas. This mixing is accomplished by such things as a turbine rotating in a tank, by venturi injection of gas into liquid passing through a pipe, by injection of gas into liquid the mixture then flowing through a static or mechanical mixer, by injection of gas into a liquid the mixture then flowing through a transfer pump, etc.

All of these mechanical mixing methods suffer from high initial equipment and operational power costs. Some have unique problems such as scale buildup in packed columns. Mechanical mixing methods generally have short contact times since the agitation damps down rapidly as soon as the mechanical action ceases. Attempts at improvement run into the barrier of diminishing efficiency as more energy is added to the gas/liquid mixture to increase agitation.

A second method is based upon making the gas bubbles very small as they enter the liquid. Usually the gas is pumped into the liquid through a porous metal or ceramic sparger, or some other type of gas diffuser, so that the gas escapes into the liquid through numerous small openings. High gas flow rates are necessary to make sparging equipment operate correctly and the ozone concentration in the feed gas is low. Mechanical mixing is often used to mix the gas bubbles with the liquid. A stream of bubbles rising through the liquid may also cause gas bubble channeling resulting in incomplete treatment. The rising bubbles tend to become spherical, which gives the lowest surface area to volume ratio, and the bubbles tend to coalesce which also reduces the surface area to volume ratio. Rising bubble technology also requires large bubble towers which are expensive and take up valuable space.

Improvement of this fine bubble technology has probably progressed about as far as it can. Some improvements, such as Olsen's U.S. Pat. No. 5,863,576, make use of unique technology, in this case treatment with a sonic generator to break the small bubbles into even smaller bubbles, but real breakthroughs in fine bubble technology are unlikely.

A third technology that has been used is breaking the liquid up into small droplets and exposing these droplets to an atmosphere containing ozone. In fine bubble technology the liquid phase is the continuous phase and in spray technology the gas is the continuous phase. The general principal is that the liquid is sprayed into a chamber and the gas is released or injected into the chamber. Walden, U.S. Pat. No. 1,077,026, in which sewage was sprayed horizontally into a chamber and the ozone was injected into the chamber from the side, and Knips, U.S. Pat. No. 1,103,211, in which sewage was sprayed vertically, like a fountain, into a chamber with ozone being fed in from the side, are general examples of this technology.

A second general pattern of spray technology is shown in McGregor, U.S. Pat. No. 1,420,046, in which the liquid to be treated was sprayed into the top of a vertical cylinder and the ozone was injected into the bottom of the cylinder so that the two flowed through the cylinder counter currently. Another example is Sawamoto, Foreign Patent EPO 430 904 A1, in which the liquid to be treated was sprayed downward into a tank and the ozone was introduced into the spray by nozzles from the sides of the tank.

As the spray of liquid enters the contact chamber the droplets tend to become spherical. This configuration has a minimum surface area to volume ratio so the total surface of the liquid exposed to the gas decreases as the droplets fall through the chamber. The spherical shape also reduces agitation and mixing within the droplet so that the target molecules in the center of the droplet depend on Brownian motion to reach the outside layers of the droplet where they can be oxidized by the ozone. The relatively slow motion of the droplets falling through the gas also allows formation of a boundary layer of gas immediately around the droplet which contains little ozone just as lack of agitation in the droplet allows formation of a boundary layer of liquid around the droplet that contains few target molecules for the ozone to oxidize.

It will be demonstrated in this patent application how the Gas/Liquid Contact Chamber overcomes the disadvantages of these various mass gas transfer technologies.

Ozone has often been regarded as a magic bullet for water purification and overenthusiastic and shortsighted sales methods have given ozone technology salesmen a general reputation of “snake oil salesmen”. The major misconception in the ozone industry is that ozone, by itself, can solve all water purification problems. The truth is that ozone is only a chemical oxidant and, for effective application, must be combined with other water and wastewater treatment techniques that can perform tasks in the treatment process that ozone cannot perform, or that it performs poorly or uneconomically.

There are some attempts reported to combine treatment technologies but these are usually confined to the improvement of the mass gas transfer process and do not speak to the broader challenges in contaminated water treatment. One example of combined treatment technologies is Hill et al, U.S. Pat. No. 5,637,231, in which ozone is mixed with sewage by venturi injection and the mixture is sprayed over a series of perforated plates, one above another, in a vertical cylinder giving, a packed column mixing effect. Another example is Hoppe, U.S. Pat. No. 5,494,576, in which ozone is mixed with contaminated water by venturi injection and then sprayed into the upper end of a cone topped cylinder where the droplets fall through an atmosphere containing ozone from the gas sprayed into the chamber and released from the droplets themselves.

The Contaminated Water Treatment System described in this patent application combines known water and wastewater treatment technology with the Gas/Liquid Contact Chamber herein described to produce a treatment system that can take contaminated water, remove or destroy the contaminants, and produce a pure, odorless, colorless, oxygenated and disinfected final effluent stream suitable for safe release into the environment or useful for other purposes.

### SUMMARY OF THE INVENTION

The present invention overcomes the problems associated with prior art by use of a unique and simple contact chamber that maximizes the surface area of the liquid to be treated exposed to a gas containing ozone promptly after passage of the gas through the ozone generator. This minimizes the negative effect of ozone's self destructive proclivity. This invention also combines the use of spray technology, gas/liquid mixing technology, and fine bubble technology for mass gas transfer from gas to liquid.

In addition, this invention combines other available water and wastewater treatment technologies to create a Contaminated Water treatment System that uses ozone's oxidizing power in solids treatment, microflocculation, odor, taste and color reduction, and water disinfection for potable water production. It does this within the confines of a simple, economical, easily constructed and highly flexible arrangement of subsystems which use proven technology and readily available commercial components and equipment.

The Gas/Liquid Contact Chamber is based upon the general concepts of spray technology described in the Description of Prior Art section. The objective is to break the liquid up into a fine spray of droplets and expose these droplets immediately to moving gas streams that contain ozone. The droplets are kept as small as possible and as highly agitated as possible during exposure to the moving streams of gas.

The chamber itself may vary in size and shape as required by the particular applications of the equipment. It must be constructed of materials resistant to sewage and ozone but, since the apparatus functions at near atmospheric pressure, does not need to withstand positive or negative pressure. Shape and size of the chamber are optimized to keep the spray droplets discrete and intact as long as possible before they strike a surface and become a flowing sheet of liquid.

The liquid enters the chamber as a cone shaped spray. Prototypes of the contact chamber were tubes with the spray entering the center of the top of the tube. The spray cone may be either hollow or solid but the solid cone is preferred.

The spray should be as fine as possible. The finer the spray the higher the liquid surface area to volume ratio is and this ratio controls the mass gas transfer rate. Production of a fine spray also breaks up solid particles and slime so that bacteria and other microbes and cysts hidden within and protected by the solid material and slime are exposed to the ozone.

The gas jets inject the ozone containing gas into the cone of spray. The gas enters the cone as a fan shaped jet wide enough to contact all droplets in the cone and at an angle such that all droplets will be exposed to the fan of gas before they contact the wall of the chamber.

At least two jets, positioned on opposite sides of the cone, are used per cone of spray. More than two jets, or an entire ring of jets, may be used if gas flow rate and ozone concentration from the generator are sufficient. Use of two jets guarantees that each droplet will contact a stream of ozone containing gas twice before losing its integrity as a droplet upon striking the walls or bottom of the chamber.

The bottom of the chamber may have internal fins positioned to direct the exiting stream of liquid and gas into a swirling chaotic flow. The purpose of such a flow will be explained later.

The Contaminated Water Treatment System consists of five subsystems each of which performs a specific step in the treatment process.

Subsystem 1—Solids Treatment and/or Separation

Subsystem 2—Gas/Liquid Contact Chamber

Subsystem 3—Retention Chamber or Tube

Subsystem 4—Gas/Liquid Separation Chamber

Subsystem 5—Ozone Destruction in Liquid

Subsystem 1, the solids handling subsystem, may be designed in various ways. It uses processes such as addition of coagulants to coagulate and precipitate solids and settling, filtration, dissolved air flotation, centrifugation, etc., to remove solids. The solids are then disposed of by landfill, incineration, composting, etc. The raw water stream may be sent through a grinder pump and then ozonated in a Gas/Liquid Contact Chamber before the solids are precipitated. Ozonation coagulates the larger solids and microflocculates the smaller solids. The ozone containing waste gas from Subsystem 4 may also be used to destroy odors in Subsystem 1.

Subsystem 2, the Gas/Liquid Contact Chamber, was described previously.

Subsystem 3, the Retention Chamber or Tube, keeps the liquid being treated in contact with the ozone containing gas for the length of time that it takes the gas/liquid mixture to pass through the chamber or tube. The chamber or tube is designed to provide active or passive mixing and agitation of the gas/liquid mixture to further promote mass gas transfer of the ozone from the gas phase to the liquid phase. The time the gas/liquid mixture spends in this subsystem may be designed to achieve a desired CT (Concentration×Time) value to guarantee the desired level of disinfection.

Subsystem 4, the Gas/Liquid Separation Chamber, is an enclosed tank into which the gas/liquid mixture from the retention subsystem is sparged and which has a headspace above the liquid which collects the gas released from the mixture. Sparging the mixture into this tank beneath the surface allows the mass transfer of ozone from gas to liquid through fine bubble technology. The gas in the top of the tank may also be recycled back through the liquid to treat the liquid farther. The recycling may be by pump and sparging or, among other possibilities, an auxiliary gas/liquid contact chamber. The gas may also be returned to Subsystem I to destroy offensive odors. In any case the residual ozone must be destroyed before venting.

Subsystem 5, Ozone Destruction in Liquid, is very simple in operation. It is a tank, a serpentine channel, or any convenient apparatus, that gives the ozone containing treated water time for the ozone to naturally dissipate or self destruct before release into the environment. Prototype work has suggested that this takes approximately thirty minutes.

### BRIEF DESCRIPTION OF THE DRAWINGS

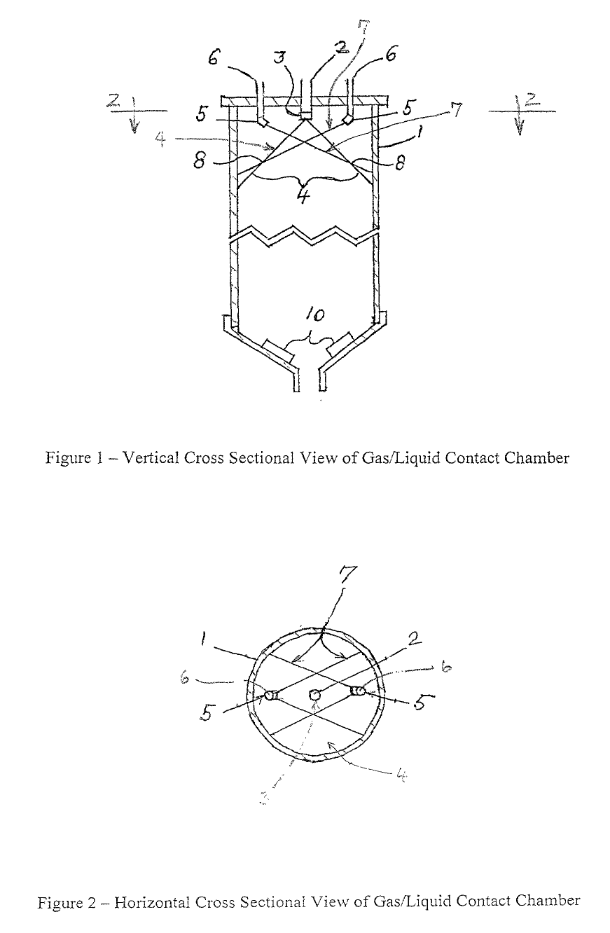

1. FIG. 1 is a vertical cross section of the Gas/Liquid Contact Chamber showing the cone of liquid spray and the angle of the jets of gas injected into the spray cone as well as the position of the vanes on the bottom cap of the chamber.

2. FIG. 2 is a horizontal cross section of the Gas/Liquid Contact Chamber showing the position of the liquid and gas lines entering the top of the chamber and the shape of the fan of gas from the gas jet and taken along line 2-2 of FIG. 1.

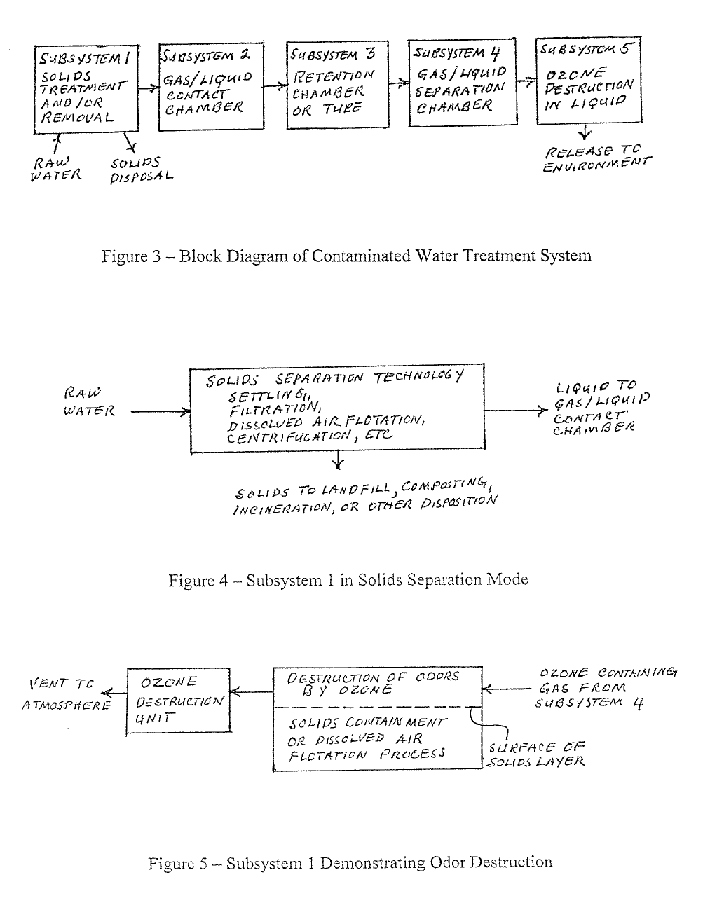

3. FIG. 3 is a block diagram of the five subsystems of the Contaminated Water Treatment System showing, the flow of liquid and solids through the system.

4. FIG. 4 is a block diagram outlining the operation of Subsystem 1 in its solids separation mode.

5. FIG. 5 is a block diagram of Subsystem 1 showing the utilization of waste ozone from Subsystem 4 for odor destruction.

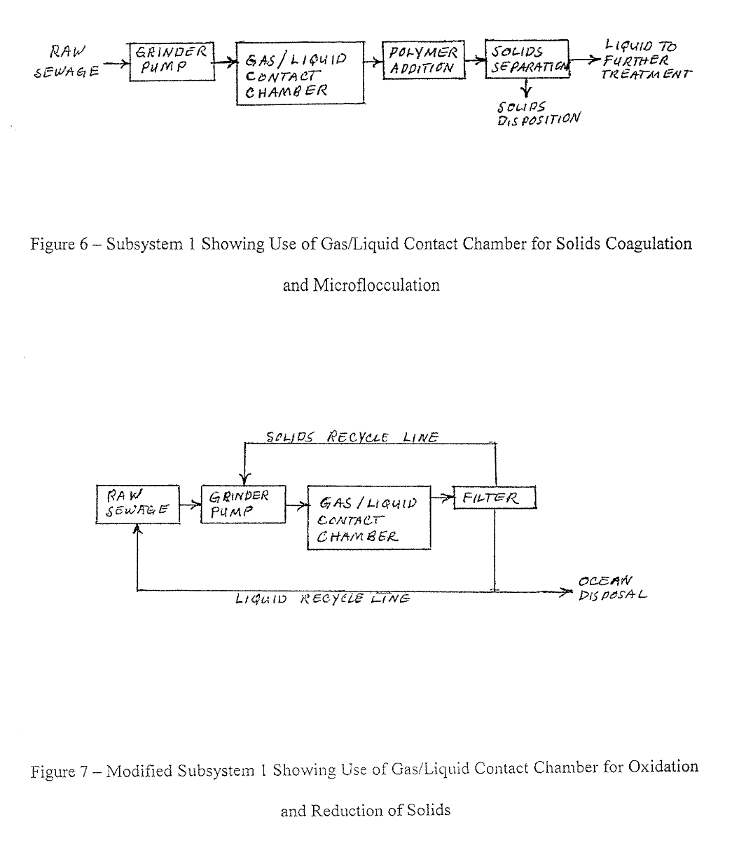

6. FIG. 6 is a block diagram of Subsystem 1 incorporating a Gas/Liquid Contact Chamber to promote solids coagulation and microflocculation.

7. FIG. 7 is a block diagram of a modified Subsystem 1 and Subsystem 2 combination, along with retention and size selective filtration, to oxidatively destroy and reduce solids size and quantity in treated sewage in preparation for marine or other disposal.

### DETAILED DESCRIPTION OF DRAWINGS

Description of Gas/Liquid Contact Chamber, Subsystem 2

Although the Gas/Liquid Contact Chamber is Subsystem 2 of the Contaminated Water Treatment System, it is the critical element of that system and will be described first.

As shown in FIGS. 1 and 2 the preferred Gas/Liquid Contact Chamber is a unique and highly effective device that maximizes the mass transfer of gases into liquids. The technology described here emphasizes the transfer of gaseous ozone into aqueous solutions but many other potential applications are possible.

The liquid to be treated enters chamber 1 through a pipe or tube 2 located in the center of the top of the chamber as best shown in FIG. 2. The liquid is sprayed into the chamber through a spray nozzle 3 to produce a cone of spray 4.

The chamber shown is a cylinder but it may be spherical or of other shapes amenable to the preservation of the spray as discrete droplets as long as possible. The chamber may also be constructed of various materials as long as the materials are resistant to the gases and liquids injected into the chamber. In the prototype work the chamber was supported at a forty five degree angle but it may also be held in a vertical position or in other positions which allow a free flow of gas and liquid into and out of the chamber.

The spray cone 4 is a solid cone of spray, not a conical sheet of liquid. It may be a hollow cone of spray under special circumstances but the optimum theoretical operation of the invention is based upon a solid cone of spray.

The angle of the sides of the spray cone 4 from the vertical is determined by the construction of the spray nozzle 3 best suited for the liquid to be treated. For example, the “pig tail” nozzle is good for viscous liquids and those containing solids. The angle of the sides of the spray cone 4, along with the size and shape of the chamber 1, determine how long the spray droplets will exist as discrete entities before coalescing into a flowing film of liquid.

The objective of the spray is to produce droplets that are as small, as irregular in shape, and as constantly in whirling or twisting motion as possible. Keeping the droplets small and maintaining them as discrete units produces the highest potential liquid surface area to liquid volume ratio possible. Keeping them irregular in shape preserves the high liquid surface area to volume ratio and also keeps the liquid in each droplet agitated so that the target molecules, or microbes if disinfection is the objective of the treatment, in the center of the droplet are constantly being brought to the surface where they can react with the ozone molecules entering the droplet.

The gas jet nozzles 5 are designed and positioned to put the ozone containing gas into contact with the liquid spray as soon as practical after the gas has left the ozone generator. Lines 6 bringing the gas from the generator (not shown) to the nozzles 5 should be as short as possible because of ozone's tendency to self destruct.

The gas is injected into the cone of spray in a fan shaped jet 7 best shown in FIG. 2. The angle of the fan of gas 7 is designed to make the edges of the fan enclose and include the greatest width of the conic section that the fan of gas 7 cuts through the cone of spray 4 before the gas passes completely through the cone of spray at 8 and continues on to the wall of the chamber 1 outside the cone of spray 4. This assures that all droplets in the cone of spray must pass through this fan of gas before contacting the bottom or sides of the chamber.

The angle of the fan of gas from the perpendicular, best shown in FIG. 1, is chosen so that the center of the fan of gas contacts the wall of the chamber a short distance above where the spray cone first contacts that same wall. The result is that every droplet in the cone of spray must pass through this fan of gas before it contacts the chamber wall or bottom.

As the fan of gas passes through the spray of liquid much of the ozone will be absorbed and the flow of gas will be disturbed by the cone of spray and drawn into the downward motion of the spray droplets. The result of this interaction, plus the widening of the fan of gas as it travels further from the gas jet nozzle, will be that the droplets furthest from the gas jet nozzle will be exposed to a lower concentration of ozone than droplets closer to the gas jet nozzle. In order to reduce this discrepancy a second gas jet nozzle is installed opposite the first gas jet with its fan of gas crossing the fan of gas from the first jet at the vertical midpoint plane of the chamber, This is best shown in FIG. 1. The result is that each droplet in the cone of spray must pass through both fans of gas, one at a higher concentration and one at a lower concentration of ozone. This exposes each droplet of spray to approximately the same total concentration of ozone containing gas before it contacts the walls or bottom of the chamber.

The concentration of ozone in the gas stream and rate of flow of gas through the jets are determined by optimization of these parameters for a particular use of the contact chamber. Data reported in the literature indicate that the lowest practical gas flow rate and the highest possible concentration of ozone in the gas at that flow rate is a good starting point for optimization.

The reactions within the chamber can be summarized as follows. A typical droplet of spray is formed at the spray nozzle and begins its journey through the chamber. It is irregular in shape and erratic in motion as it dissipates the energy given it by being formed and ejected from the spray nozzle. As it passes through the first jet of gas it absorbs ozone which reacts with the target molecules and microbes in solution and suspension and this leaves space in the droplet for more ozone to be absorbed. The agitation and mixing within the droplet keeps moving more target molecules and microbes from the interior of the droplet to the surface layers where they quickly react with the absorbed ozone. This leaves room for more target molecules and microbes to move to the surface of the droplet where they can be oxidized. This process continues until the droplet contacts the sides or bottom of the chamber to become part of the liquid stream flowing down and out of the chamber.

From the point of view of the gas phase each droplet acts like an ozone sponge and absorbs all of the ozone out of the boundary layer immediately surrounding the droplet. The cross currents and flows within the gas phase constantly remove the boundary layer from around the droplet and replace it with gas containing ozone. This ozone is absorbed by the droplet and the process is repeated until the droplet becomes part of the liquid flow.

The droplets coalesce on the walls and bottom of the chamber to form a film of liquid which flows to the bottom of the chamber and the mixture of gas and liquid leaves the chamber through the outlet port in a turbulent flow. This flow may be directed and controlled by vanes 10 installed in the outlet cap of the chamber.

Description of the Contaminated Water Treatment System

Although the Gas/Liquid Contact Chamber described here is a unique and very effective tool to ozonate water for purification it cannot perform the whole task alone. Too often in the past ozone has been touted as a nearly magical answer to water purification problems. Effective use of the Gas/Liquid Contact Chamber and the oxidizing and sterilizing power of ozone requires a systematic chain of processes where each step is designed to efficiently perform its task in conjunction with other parts of the system to achieve the desired goal.

As described here, and shown in FIGS. 3 through 7, the preferred Contaminated Water Treatment System is centered around ozonation of contaminated water using the Gas/Liquid Contact Chamber described above. It consists of various technologies and methods which, in combination with the Gas/Liquid Contact Chamber, are able to purify contaminated water and produce an effluent stream meeting the criteria of purity desired for that stream.

A system for water and wastewater treatment consists of several subsystems and technologies put together in an organized fashion. A municipal wastewater treatment plant has subsystems that remove and dispose of solids, aeration tanks where soluble BOD is oxidized and converted to insoluble BOD by microbial action, settling tanks for removal of the biosolids produced in the aeration tanks, polishing filters for the removal of fine solids not removed in the settling tanks, a disinfection step which usually consists of chlorination and dechlorination, and finally aeration and release to the environment. A municipal water treatment plant begins with a rough settling process to remove sand and mud, then the addition of a coagulant which precipitates suspended solids, a settling step to remove the coagulated solids, filtration, decolorization, deodorization, and finally disinfection, usually by chlorination, and delivery to the customer.

The Contaminated Water Treatment System described here consists of five subsystems. These are best shown in the block diagram of FIG. 3. The flow of water through the system is shown by the arrows between the subsystems. The individual subsystems and their operation are described below.

Description of Subsystem 1—Solids Treatment and/or Removal

Subsystem 1 is the Solids Treatment and/or Removal Subsystem. The simplest solids removal technology is to allow the solids to settle and decant the supernatant. Numerous methods have been devised to improve solids removal and some typical examples of these methods are shown in the block diagram of FIG. 4.

Subsystem 1 Application—Odor Treatment and Removal

One of the most prevalent problems in the treatment, removal, or handling of sewage solids is odor. Odor complaints by citizens are considered a fact of life and odor treatment processes are expensive. In FIG. 5 the use of waste ozone in the gas collected from Subsystem 4 for odor control in Subsystem 1 is shown. The tank containing the solids, or the solids separation system, must be enclosed so that the ozone containing gas can escape to the atmosphere only through the ozone destruction unit. This deodorization process makes use of even very small amounts of ozone that would otherwise be wasted and solves a serious problem that limits the selection of sites for wastewater treatment plants to isolated areas where odor is not a problem or necessitates installation of odor control technology.

Subsystem 1 Application—Ozone Mediated Solids Coagulation and Microflocculation

Ozonation affects wastewater solids by oxidizing the surface layers of the particles and changing their electrical charges and chemical affinities. This has a coagulating effect on the solids and reduces the volume of settleable solids. When fine particles that would not coagulate without ozonation are coagulated by ozone the process is termed microflocculation. This microflocculation effect of ozone can be particularly important in unique situations such as very cold water sources for water treatment plants. In such cases common coagulants often do not operate efficiently. A subsystem design that takes advantage of the coagulating ability of ozone is shown in FIG. 6.

Subsystem 1 Application—Ozone Oxidation and Destruction of Solids

In some applications chemical oxidation and destruction of solids in the waste stream is desirable. An example is a waste disposal system that is often installed in ocean going vessels which uses chlorine or hypochlorite as an oxidizing agent, and combines that with grinding, filtration, recycling and dilution to reduce the solids concentration to a level that allows ocean discharge. The Gas/Liquid Contact Chamber may be substituted for the chlorine or hypochlorite oxidizing agent and a much more ecologically friendly effluent, one not containing chlorine or chlorinated byproducts, would be produced. A subsystem design to do this is shown in FIG. 7.

Description of Subsystem 2—Gas/Liquid Contact Chamber

The design and operation of Subsystem 2, the Gas/Liquid Contact Chamber, has already been discussed.

Subsystem 2 Application—Stand Alone Ozonation

The Gas/Liquid Contact Chamber may be used as a stand alone unit to produce solutions of various gases in various liquids. This opens up new uses for this invention. For instance, in the case of ozone solutions in water, these can be used for cleaning and sterilizing purposes and may also be used for washing and disinfecting foodstuffs such as vegetables, fruits, and meats. Another potential use of the stand alone system is in removal of a soluble gas, such as sulfur dioxide, from a gas stream, such as air.

Description of Subsystem 3—Retention Chamber or Tube

The susceptibility of organic molecules to oxidation by ozone varies widely. Concentration of ozone in the liquid phase and time of exposure of the target molecules to the ozone are two of the controlling factors in this oxidation.

When a solution containing several different target compounds exits the spray nozzle into the contact chamber the ozone transferred into the droplets is used up very quickly by the most easily oxidized target compounds. As the concentration of these compounds is reduced the concentration of ozone in the droplet is increased and more recalcitrant target molecules are attacked.

This process continues as the droplets coalesce to form a stream of liquid flowing out of the chamber. Ozone molecules continue to enter this flowing liquid phase even though this happens at a drastically reduced rate compared to the ozone mass transfer rate when the liquid was in droplet form. This reduction in mass transfer rate is because the flowing liquid has a much lower surface area to volume ratio than the droplet phase does.

For this lesser, but still valuable, mass gas transfer to continue, and for maintenance of the ozone concentration in the liquid for the time required to achieve the CT (Concentration×Time) value needed to achieve adequate disinfection of the effluent, the liquid must be kept in contact with the ozone containing gas.

In the Contaminated Water Treatment System this retention of the gas and liquid phases in turbulent contact with each other is accomplished by a retention system consisting of a coiled, convoluted, or straight tube, an enclosed tank that is baffled, convoluted, or mechanically mixed, a static mixer apparatus, or any of a multitude of such options that serve to keep the gas and liquid phases in agitated contact as they flow from the contact chamber to the gas/liquid separation subsystem. The length and form of this retention chamber is optimized to achieve the desired level of treatment within the confines of the installation site.

Description of Subsystem 4—Gas/Liquid Separation

Federal and State regulations prohibit the venting of ozone to the atmosphere. The function of this subsystem is to separate the ozone containing waste gas, probably also rich in oxygen, so that the ozone and oxygen may be used for other purposes in the treatment system or the ozone can be destroyed before the waste gas is vented to the atmosphere.

The structure of this subsystem can be very simple. An enclosed tank with an inlet connected to a subsurface sparger unit at one end, an outlet for liquid to Subsystem 5 at the other end, and adequate headspace, is sufficient. The gas/liquid mixture from the retention chamber or coil is sparged into the collected liquid below the liquid surface so that the ozone has another opportunity to enter the liquid through the application of fine bubble technology.

Subsystem 4 Application—Reuse of Collected Gas

The gas collected from this subsystem may be pumped from the headspace of the tank and sparged or mixed back into the liquid in the tank to use the residual ozone. An auxiliary Gas/Liquid Contact Chamber may be used. The gas may also be piped to Subsystem 1 and used for odor control as discussed previously or may be used to preaerate and deodorize the raw sewage coming into the plant. Wherever this gas is used it is necessary to destroy the residual ozone before venting the waste gas to the atmosphere.

Subsystem 4 Application—Feedback control of Ozone Supply to Subsystem 2

Sensors to determine ozone content in both gas and liquid may be installed in Subsystem 4. The concentration of ozone determined by these sensors may be used to control the ozone generator used to produce ozone for Subsystem 2. This allows the operator to optimize the efficiency of the Contaminated Water Treatment System.

Description of Subsystem 5—Ozone Destruction in Final Effluent

Ozone is regulated as far as the amount that can be released into the environment either as a gas or as an aqueous solution. Ozone, unlike chlorine and dechlorination chemicals, self destructs in a reasonable length of time and therefore does not need a special deozonation treatment step but only requires retention for the time required for it to self destruct. Samples of final effluent from local sewage treatment plants were ozonated, using prototype equipment, as a substitute for the chlorination/dechlorination disinfection step. The samples were taken from the plant effluent prior to chlorine disinfection. The ozone in these effluents, concentrations were between one and two milligrams per liter, dissipated to an undetectable level in thirty minutes under normal conditions. The resultant effluent met regulatory limits for fecal coliform counts for release into the environment and was also nontoxic to fathead minnows.

The ozone dissipation step may be accomplished in a tank, a series of tanks, a serpentine channel, or any such method that allows about thirty minutes retention time before release into the environment.

List of Unique Attributes and Applications of this Invention

Utilization of Multiple Methods of Mass Gas Transfer in a Single Contaminated Water Treatment System.

In almost all attempts to use ozone in water and wastewater treatment systems the emphasis has been upon developing a single method for transferring ozone from the gas phase to the liquid phase and treating the liquid with that single method. In the Contaminated Water Treatment System described in this application the liquid is first ozonated in the Gas/Liquid Contact Chamber by spray technology, then ozonated in the retention subsystem by gas/liquid mixing technology, and finally ozonated in the gas/liquid separation subsystem by fine bubble technology. The treatment system thus uses all three of the major methods for mass gas transfer into liquid.

Utilization of Multiple Gas Jets Per Liquid Spray Cone

In FIGS. 1 and 2 the Gas/Liquid Contact Chamber is shown containing only two gas jets per liquid spray cone. The number of gas jets per liquid spray cone may be increased if available gas flow, ozone content in the feed gas, and pilot plant results warrant such an increase. All gas jets should enter the spray cone at the angle described unless optimization experiments show that a modification of that angle improves the results. It is even possible to use a ring of gas jets surrounding the spray cone. The number of gas jets per spray cone is determined by the purpose of the treatment and by pilot plant optimization of the subsystem design.

Multiple Liquid Spray Nozzles and Gas Jets in a Single Chamber

For large flow applications, such as disinfection of the final effluent of a large municipal wastewater treatment plant, the use of multiple chambers, each containing only a single liquid spray cone, would become unwieldy. The installation of several liquid spray nozzles, each accompanied by two or more gas jets, in a single large chamber would allow the treatment of large flows in a total space less than that required for single spray nozzle chambers. All design parameters would remain the same except for the size and shape of the chamber. This arrangement would theoretically be more effective than multiple single spray cone chambers since more of the droplets would remain discrete for a longer period of time. The shape of the multiple spray nozzle chamber would be determined by the needs of each application.

Flexibility of Subsystem Installation

The liquid transfer line from Subsystem 1 to Subsystem 2 may be any length that is convenient for the operation. The same goes for other connecting lines between the subsystems. Thus the subsystems may be arranged and installed as space within the site is available. This flexibility allows installation of the Contaminated Water Treatment System on sites where space is at a premium or is broken up.

Specialized Applications of Individual Subsystems

The use of Subsystem 2 in stand alone ozonation applications has already been discussed. Subsystem 2 may also be used to wash an unwanted gaseous component, such as sulfur dioxide, from a gas stream by spraying an alkaline aqueous solution through the liquid spray nozzle and injecting the contaminated gas through the gas jets. Subsystem 2 may also be used to oxygenate a sewage stream to be fed into an activated sludge treatment plant. Supersaturated oxygen levels are achieved by use of Subsystem 2 with oxygen enriched air, or unenriched air, fed to the gas jets.

Combinations of two or more subsystems to accomplish specific tasks are also possible. One example would be the combination of Subsystem 1 and Subsystem 2 to treat seepage that contains oil and other suspended solids from a landfill. Subsystem 1 would combine technologies to remove suspended and floating solids and floating oil and Subsystem 2 would be used to destroy organic contaminants and oxidize heavy metals for precipitation and removal from the Subsystem 1 effluent.

Potable Water Production

Use of the Contaminated Water Treatment System to produce potable water is based upon the operation of a municipal water treatment plant. The suspended solids in the raw water would be precipitated and removed in Subsystem 1. The water would then be filtered and ozonated in Subsystem 2. The retention time in Subsystem 3 and holding time in Subsystem 4 would be designed to produce CT values that would guarantee adequate sterilization for this application. Subsystem 5 would serve as a chlorination and holding tank to adequately chlorinate the finished water before distribution to the consumer. This arrangement of equipment and processes could be very effectively used as an emergency water system for small communities or as an adjunct to water treatment plants of insufficient capacity.

Use of the Contaminated Water Treatment System with Artificial Wetlands as Final Polishing Step

Space for new housing developments is at a premium in many parts of the world. Much land available for development is unsuitable for septic tank installation and is far removed from water and wastewater treatment facilities. A small, self contained sewage treatment facility utilizable by individual housing developments is needed.

The use of the Contaminated Water Treatment System with substitution of an artificial wetlands final polishing step for Subsystem 5 would solve these problems and open up large tracts of land for development that are now unusable. The treated wastewater, along with rain runoff from the housing development, would return more fresh water to the receiving stream than was removed to provide potable water to the housing development.

Substitution of Ozone for Chlorination/Dechlorination as the Final Disinfection Step for Wastewater Treatment Plant Effluents

One of the most pernicious problems associated with wastewater treatment plants are spills of chlorine and dechlorination chemicals used in the disinfection step of the final effluents of these plants. Disinfection is necessary because of the high content of fecal coliform and associated pathogenic organisms found in the undisinfected effluent of even the best of sewage treatment plants. Regulatory agencies and environmentalists are constantly on the lookout for new technologies and potential substitutes for chlorine and dechlorination chemicals.

The Gas/Liquid Contact Chamber described herein overcomes the technological and economic objections to the substitution of ozonation for the chlorination/dechlorination process commonly used. As discussed previously deozonation is not necessary because ozone self destructs to a nontoxic level within a reasonable time.

Experimental work with contact chamber prototypes has proven the effectiveness of this substitution as shown in the table below.

Fecal coliform count in CFU per 100 ml

| Plant | Before Ozonation | After Ozonation |
|---|---|---|
| #1 | 7,800 | 1 |
| #2 | 16,000 | 150 |
| #3 | 42,200 | 14 |
| #4 | 17,300 | 8 |

The post ozonation fecal coliform counts met regulatory requirements for the release of the effluent into the environment in all cases. The treated effluent was also decolorized and deodorized and well as being saturated with oxygen and thus did not require any post disinfection aeration or oxygenation.

Addendum to “Multiple Liquid Spray Nozzles and Gas Jets in a Single Chamber”.

Up to this point the tacit assumption has been made that a contact chamber necessarily has discrete walls that contain the liquid and gas that are interacting. This is not necessarily so because the initial and predominant transfer of ozone from gas to liquid takes place during the passage of the fan of gas through the cone of spray. This takes place whether chamber walls are present or not. The basic arrangement of liquid spray nozzle and gas jets can be assembled so that both the liquid spray cone and the jets of gas could pass into the atmosphere, after the fan of gas has passed through the cone of spray, and not contact any chamber walls or bottom at all. This type of assembly could be used to wash meats and vegetables, spray growing vegetables with ozonated water, and many other applications. Care must be taken that undesirable concentrations of excess ozone, ozone not absorbed by the liquid spray, are not released into the atmosphere. This can be accomplished by control of the ozone concentration in the gas stream fed to the gas jets.

What is claimed is:

1. An apparatus for providing contact between a liquid and a gas comprising:
a first nozzle adapted for spraying a cone pattern;
a second nozzle adapted for spraying a fan pattern;
said first and second nozzles positioned for directing said cone pattern and said fan pattern in an intersecting path with one another, whereby a gas or liquid sprayed through said first nozzle contacts the other of said gas or liquid sprayed through said second nozzle.

2. The apparatus of claim 1 comprising at least two of said second nozzles positioned for directing their respective fan pattern sprays generally toward and in an intersecting path with one another and toward and in an intersecting path with said first nozzle cone spray pattern.

3. The apparatus of claim 2 wherein said first nozzle is positioned for directing said cone pattern vertically downwardly.

4. The apparatus of claim 3 wherein a liquid is sprayed through said first nozzle in a cone pattern and a gas is sprayed through said second nozzles in a fan pattern.

5. The apparatus of claim 4 wherein said first nozzle is adapted for spraying a solid cone pattern.

6. The apparatus of claim 4 wherein said first nozzle is adapted for spraying a hollow cone pattern.

7. The apparatus of claim 3 wherein said first nozzle is adapted for spraying water and said second nozzles are adapted for spraying ozone.

8. The apparatus of claim 7 wherein said first nozzle is adapted for spraying a solid cone pattern.

9. The apparatus of claim 7 wherein said first nozzle is adapted for spraying a hollow cone pattern.

10. The apparatus of claim 7 further comprising a chamber wherein said first and second nozzles are directed, said cone pattern spray and said fan pattern sprays being directed into said chamber.

11. The apparatus of claim 1 wherein said first nozzle is positioned for directing said cone pattern vertically downwardly.

12. The apparatus of claim 11 wherein said first nozzle is adapted for spraying water and said second nozzle is adapted for spraying ozone.

13. The apparatus of claim 12 wherein said first nozzle is adapted for spraying a solid cone pattern.

14. The apparatus of claim 12 wherein said first nozzle is adapted for spraying a hollow cone pattern.

15. The apparatus of claim 1 wherein said first nozzle is adapted for spraying water and said second nozzle is adapted for spraying ozone.

16. The apparatus of claim 1 further comprising a chamber wherein said first and second nozzle are directed, said cone pattern spray and said fan pattern spray being directed into said chamber.

17. A method of providing contact between a liquid and a gas comprising the steps of:
spraying one of a liquid or gas in a cone pattern; and,
spraying the other of the liquid or gas in a fan pattern and in a direction intersecting said cone pattern, whereby the gas and liquid come in contact with one another.

18. The method of claim 17 wherein a liquid is sprayed in said cone pattern and a gas is sprayed is said fan pattern.

19. The method of claim 18 wherein at least two fan pattern sprays of gas are provided and are sprayed in a direction toward and intersecting said cone pattern sprayed liquid.

20. The method of claim 19 wherein the liquid being sprayed is water and the gas being sprayed is ozone, whereby contact between the water and ozone is provided.

21. The method of claim 20 wherein said spraying of said cone of water is directed generally vertically downwardly.

22. The method of claim 21 wherein the water is sprayed in a hollow cone pattern.

23. The method of claim 21 wherein said water is sprayed in a solid cone pattern.

24. The method of claim 21 wherein said cone pattern spray of water and said fan pattern spray of ozone are directed into a chamber.
